(19) United States
(12) Patent Application Publication
(10) Pub. No.: US 2016/0143234 A1
(43) Pub. Date: May 26, 2016

(54) TUBULAR GREENING UNIT

(71) Applicant: NASSUN. E CORPORATION, Tochigi (JP)

(72) Inventor: Masakazu NASU, Sakura-shi, Tochigi (JP)

(73) Assignee: NASSUN. E CORPORATION, Sakura-shi, Tochigi (JP)

(21) Appl. No.: 14/895,700

(22) PCT Filed: Jun. 4, 2014
(86) PCT No.: PCT/JP2014/064872

§ 371 Date: Dec. 3, 2015

(30) Foreign Application Priority Data
Jun. 12, 2013 (JP) 2013-124235

(51) Int. Cl. A01G 31/02

(52) U.S. Cl. CPC A01G 31/02

(57) ABSTRACT

[Problem] There has been needed a greening unit in which watering is simple and flexibility in installation is high when arranging a number of plants in the vertical direction.

[Solution] The greening unit includes at least one or more case members. Each of the case members is substantially rectangular, can be bent in the width direction, and has an element of a fastener on each side along the longitudinal direction. The element is closed by sliders of a fastener to form a hollow body constituted by the case member. A plant cultivation base material is poured into the hollow body. Two or more of the sliders are disposed to one fastener structure. Positions of the sliders are adjusted to form an opening along part of the fastener. A plant can be planted to the plant cultivation base material through the opening.

### TECHNICAL FIELD

The present invention relates to plant raising and greening. In particular, the present invention relates to a tubular greening unit in which the planting region and the planting position can be optionally adjusted, and watering is easily performed thereby promoting aesthetic greening.

### BACKGROUND ART

When attempting to densely arranging plants in a narrow area or in the vertical direction for gardening in homes, there are commonly used a method of allowing climbing plants to creep around wires, string-like nets, or the like, and a method of arranging a plurality of hanging flower pots (hereinafter, referred to as hanging baskets) on a wall.

However, when applicable plants are limited to climbing plants, types of plants are restricted. Furthermore, in the case of hanging flower pots, which need to be individually watered, time and labor are required. Therefore, there is needed a greening unit in which watering is easily performed.

Also, when attempting to fabricate green curtains with climbing plants, leaves sometimes fail to be uniformly raised depending on the growing state of the plants. In this case, it is difficult to add plants to places where leaves are scarce. In the case of hanging baskets, each of the hanging baskets requires a wall or a rack on which it is arranged. Therefore, it has been difficult to optionally determine the position to be arranged. Consequently, there is needed a greening unit in which plants can be arranged at optional positions.

Green curtains are effective for shielding light. However, green curtains sometimes cause an inside of a room to become dark depending on the weather. Green curtains are difficult to temporarily draw, unlike common curtains. Furthermore, green curtains are constituted by climbing plants. Since climbing plants are entangled with each other once they have grown up, a human can rarely pass through the green curtains. In some cases, it is more convenient to pass through green curtains. However, this is difficult because of the nature of climbing plants. Therefore, there is needed a greening unit that is a green curtain capable of being temporarily moved and partly bent so that a human passes through, like known curtains.

Also, when hanging baskets are hung while they are linked to each other, water mixed with soil flows out from the bottom of each of the flower pots during watering. Water flowing out from a flower pot arranged at a relatively high position spatters, thereby messing its surroundings. Many of the flower pots which are hung while linked to each other are often arranged in busy places for ornamental purposes. For this reason, it is not preferred that water mixed with soil spatters.

Also, in some hanging flower pots, plants can be horizontally planted from the sides. This type of flower pot has a slit on the side surface of the hanging pot. A plant can be inserted through the slit for planting. However, merely disposing a slit may sometimes cause water or soil to spill from the slit during watering. In some flower pot, a sponge for reducing the soil spill is bonded to the slit. Even in such a case, the sponge fails to come into intimate contact with a space between stems of a plant having a plurality of stems. Accordingly, this type of flower pot has been insufficient for suppressing spillage of water and soil. Thus, there is needed a greening unit in which water mixed with soil does not spatter even when the plant is cultivated at a relatively high place.

The yield per unit area when vegetables or the like are cultivated in known flower pots or outdoors is limited. Nevertheless, if racks or the like are arranged and plants are cultivated in flower pots placed on the racks or the like, time and labor during harvesting increase. Therefore, there is needed a greening unit in which only minor working loads are required during harvesting even when the yield per unit area is increased.

In view of such problems, various technologies have been proposed. For example, there has been proposed a “greening shelf unit disposed on a wall surface such as a retaining wall, as a greening unit to be disposed to a surface or a wall.” This technology has become a known art (see Patent Literature 1). Such a technology is specifically a greening unit, for a wall surface, having a plurality of tilted vegetation support shelves. The vegetation support shelves of this greening unit are piled up in the vertical direction. Culture media such as soil are in contact with each other between the vegetation support shelves.

However, in this greening shelf unit, positions where plants are planted are simply piled up in the vertical direction. Accordingly, there is no description on the method of preventing water and soil from spattering during watering, and on the temporary movement of a greening unit. This greening unit does not solve the problems.

There has also been proposed a greening cultivation container that is a vertical-type cultivation container, enables uniform watering, and has good maintenance properties. This technology has become a known art (see Patent Literature 2). Such a technology relates to a “greening cultivation container including: a cultivation container body having a container shape and having on the front surface an opening for planting; a water feeding unit disposed on the upper side of the cultivation container body; a watering unit disposed on the upper portion within the cultivation container body in a corresponding manner to the water feeding unit; and a dewatering unit attached to the lower portion within the cultivation container body. The watering unit contains permeable porous foam.

However, this greening cultivation container has a structure in which holes are simply disposed on the side surfaces of the cultivation container. There is no description on spattering of water during watering as well as on temporary movement of a greening unit. Thus, this greening cultivation container does not solve the problems.

There has been further proposed a “decorative greening apparatus that can decorate with plants and cultivate plants in good conditions even with a small amount of culture liquid, thereby enabling excellent water management and easy arrangement and utilization even indoors.” This technology has become a known art (see Patent Literature 3). Such a technology relates to a “decorative greening apparatus including: a non-permeable cultivation tubular body, constituted by a hollow tube disposed such that its tubular central axis runs in the vertical direction, which has on a peripheral wall a plurality of insertion holes into which roots of plants can be inserted; a thin, hollow tube-like water-retaining material which is peripherally furnished so as to come into contact with an inner wall of the cultivation tubular body; a culture liquid supplying unit that supplies the water-retaining material with the culture liquid; and a non-permeable tubular support that is a hollow tubular body smaller than the cultivation tubular body, is disposed inside the water-retaining material in contact with the inner wall of the cultivation tubular body, and has a holding force of holding the water-retaining material between the cultivation tubular body and the support.

However, this decorative greening apparatus has a structure for cultivating relatively small plants under an aquatic environment in a space formed on the side. For this reason, the application of this structure is different from that of common plant cultivation with soil. There is no description on temporary movement of a greening unit. Therefore, this decorative greening apparatus does not solve the problems.

In order to solve these problems, the present inventor focused on the linking function of a fastener and the positioning function by a slider. Application of these functions to a plant cultivation container or a greening unit enables optional adjustment of planting regions, and furthermore, optional setting of planting positions and the number of planting sites. Based on such an idea, the present inventor has proposed a “tubular greening unit” according to the present application.

### CITATION LIST

### Patent Literature

PATENT LITERATURE 1: JP-A-2009-254347
PATENT LITERATURE 2: JP-A-8-238028
PATENT LITERATURE 3: Japanese Utility Model No. 3160800

### SUMMARY OF THE INVENTION

### Problems to be Solved by the Invention

In view of the above-described problems, the present invention proposes to provide a tubular greening unit in which planting regions and planting positions can be optionally adjusted, and watering is easily performed, thereby decreasing burdens of gardeners and promoting aesthetic greening with plants in stores or the like.

### Solution to the Problems

A greening unit, according to the present invention, in which various plants are allowed to be planted at an arbitrary position, adopts an unit in which: the unit includes at least one or more case members; each of the case members contains a material capable of bending, and has an element of a fastener on two sides that serve as a pair; the element is closed by sliders of the fastener to form a hollow body having a hollow region enclosed with the case member; a plant cultivation base material is poured into the hollow region; at least two or more of the sliders are disposed to one fastener structure; and positions of the sliders are adjusted to form an opening along part of the fastener, and a plant is allowed to be planted to the plant cultivation base material through the opening.

In the present invention, an unit in which in the case member, one or both of at least one or more slit portions and at least one or more slit portions with the fastener by the sliders are disposed at arbitrary positions in an interior region between the elements of the fasteners on the two sides that serve as a pair may also be adopted.

In the present invention, an unit in which a watering pipe is disposed inside the hollow region of the hollow body, at least one or more watering holes are disposed to the watering pipe, and water poured into the watering pipe is supplied to the plant cultivation base material through the watering holes may also be adopted.

In the present invention, an unit including an arrangement structure in which a water-retaining material covers a periphery of the watering pipe, and the plant cultivation base material is poured into the hollow region on a periphery of the water-retaining material may also be adopted.

In the present invention, an unit in which the hollow region of the hollow body includes: a poured region in which the plant cultivation base material is poured; and a non-poured region in which the plant cultivation base material is not poured, and the hollow body is capable of bending at the non-poured region may also be adopted.

In the present invention, an unit in which: the unit further includes an adapter that is to be inserted into the opening, and gradually leads the plant from the opening to a direction parallel to the ground to hold the plant; two flange-like steps, each having an area wider than an opened plane of the opening, are formed to the adapter; and the adapter is a plant-holding adapter that holds the case member between the flange-like steps for preventing the plant cultivation base material from leaking from the case member may also be adopted.

In the present invention, a unit in which the plant-holding adapter is a plant-holding adapter having a divided structure in which a pipe line of the adapter is halved may also be adopted.

In the present invention, a unit in which the greening unit includes an engaging tool disposed on an edge of the greening unit, and is to be hung on an engaged object via the engaging tool for arrangement may also be adopted.

### EFFECTS OF THE INVENTION

According to the greening unit of the present invention, a wide variety of plants can be simultaneously cultivated even in a relatively small arrangement region either indoors or outdoors. Furthermore, watering is easily performed. This greening unit can also be temporarily moved or arranged. Therefore, there are exerted excellent effects of reducing working burdens and achieving efficient works in seedling raising and gardening.

Furthermore, according to the greening unit of the present invention, the use of sliders enables an opening of a fastener to be created at an optional position. The size of a container body can also be optionally adjusted only by linking with the fastener.

Therefore, the greening unit of the present invention can be used for a wide range of purposes, from easy gardening at home, to utilization as windows or wall surfaces in stores or as displays for large-scale decoration in event sites. Such excellent effects, which have not been demonstrated in conventional technologies, can be exerted.

### BRIEF DESCRIPTION OF THE DRAWINGS

FIG. 1 is an entire perspective view of a greening unit according to the present invention.

FIG. 2 is a state view in which plants are planted in the greening unit according to the present invention.

FIG. 3 is a cross-sectional view of the greening unit according to the present invention.

FIG. 4 is an exploded view of the greening unit according to the present invention.

FIG. 5 is a view illustrating a planting example of the greening unit according to the present invention.

FIG. 6 is a view illustrating an example of a watering pipe of the greening unit according to the present invention.

FIG. 7 is a view illustrating an example of a water-retaining material of the greening unit according to the present invention.

FIG. 8 is a view illustrating an example of a bending structure of the greening unit according to the present invention.

FIG. 9 is an illustrative view of a plant-holding adapter according to the present invention.

FIG. 10 is illustration of a divided structure of the plant-holding adapter according to the present invention.

FIG. 11 is a perspective view of an example in which the greening unit according to the present invention is structured into a green curtain type.

FIG. 12 is an illustrative view of an example in which the greening unit according to the present invention is structured into a wall shape.

FIG. 13 is an illustrative view of an example in which the greening unit according to the present invention is structured into a spiral shape.

FIG. 14 is a development view of a case member according to another structure of the greening unit according to the present invention.

FIG. 15 is a development view illustrating examples according to other embodiments of the greening unit according to the present invention.

FIG. 16 is an illustrative diagram of an automatic water supply system of the greening unit according to the present invention.

### DESCRIPTION OF EMBODIMENTS

A greening unit 10 which is the present invention includes a hollow body 101 having openings on its top and bottom, so that watering can be easily performed, and planting regions and planting positions can be optionally adjusted, when arranging a number of plants in the vertical direction. The hollow body 101 includes, as the most significant characteristics, a case member 602, a slider 603 of a fastener, an element 601, and a plant cultivation base material 1101. Hereinafter, an example will be described based on the drawings. It is noted that the entire shape of the greening unit 10 and the shape of each component indicated in this example are not limited to the below-described example, which can be modified within the scope of the technical idea of the present invention, that is, within the scope of the shape and dimension that allow for exertion of the same operation and effect.

### EXAMPLE 1

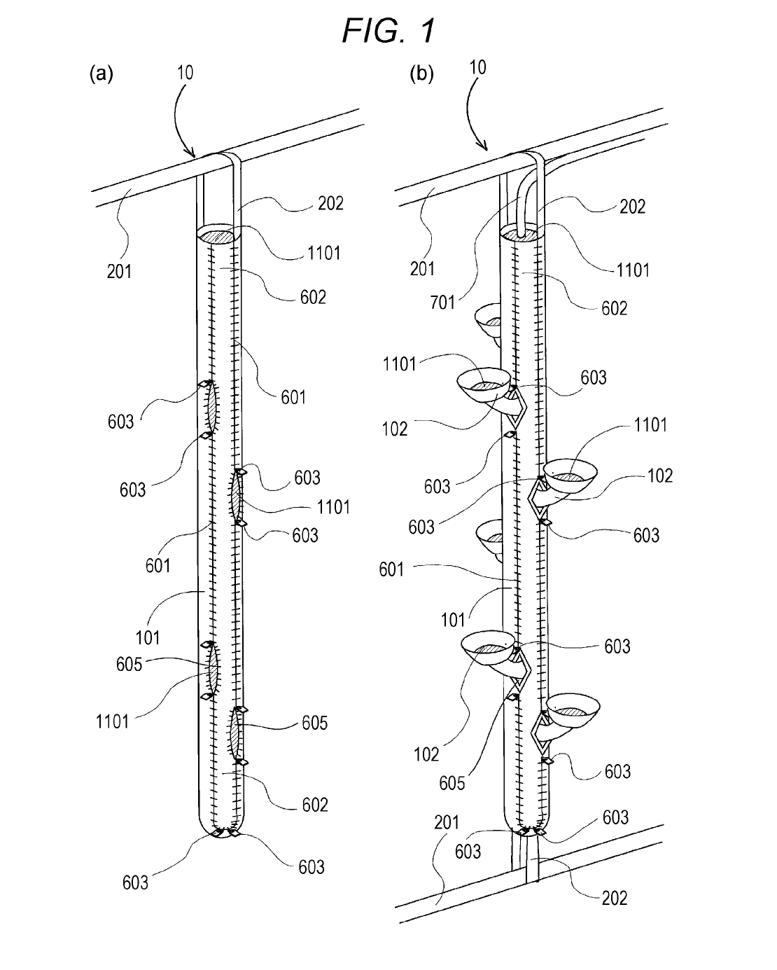

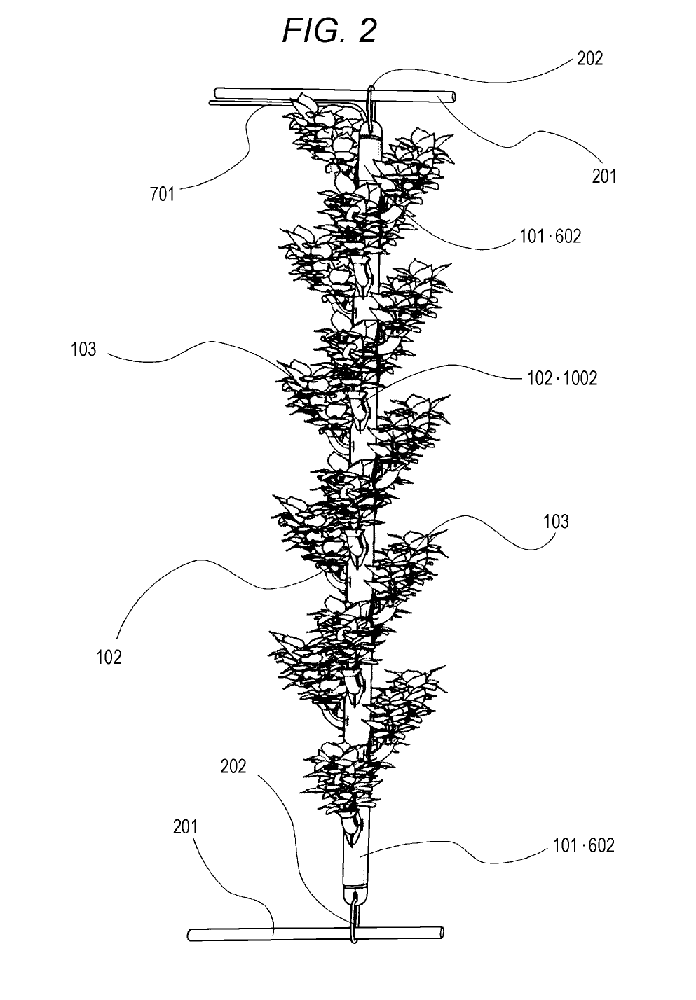

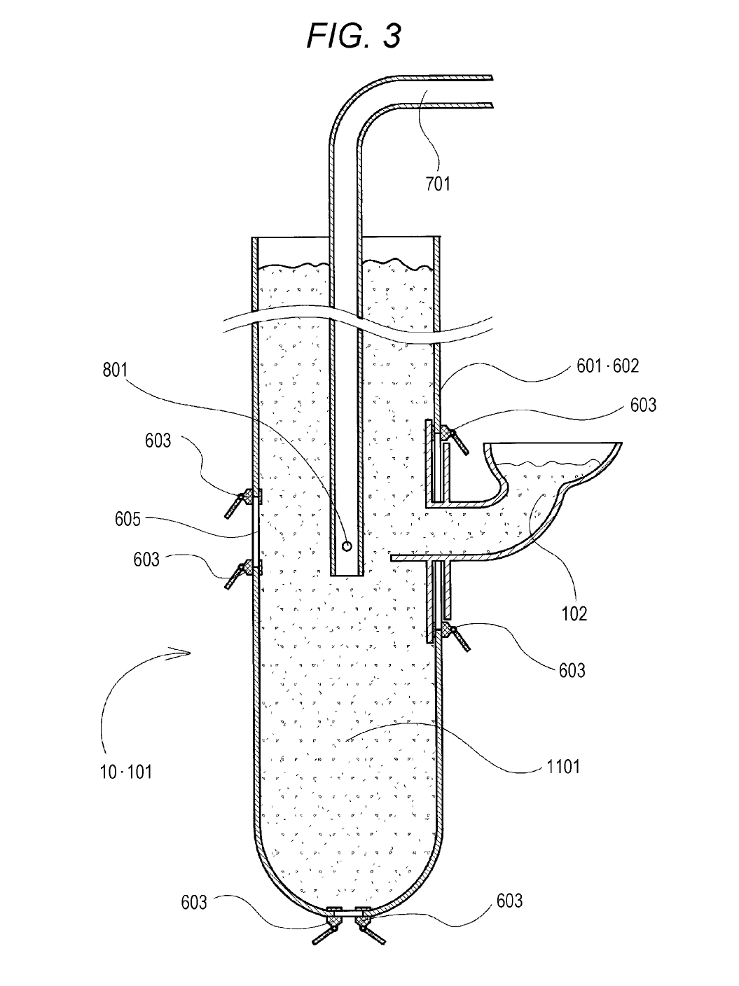

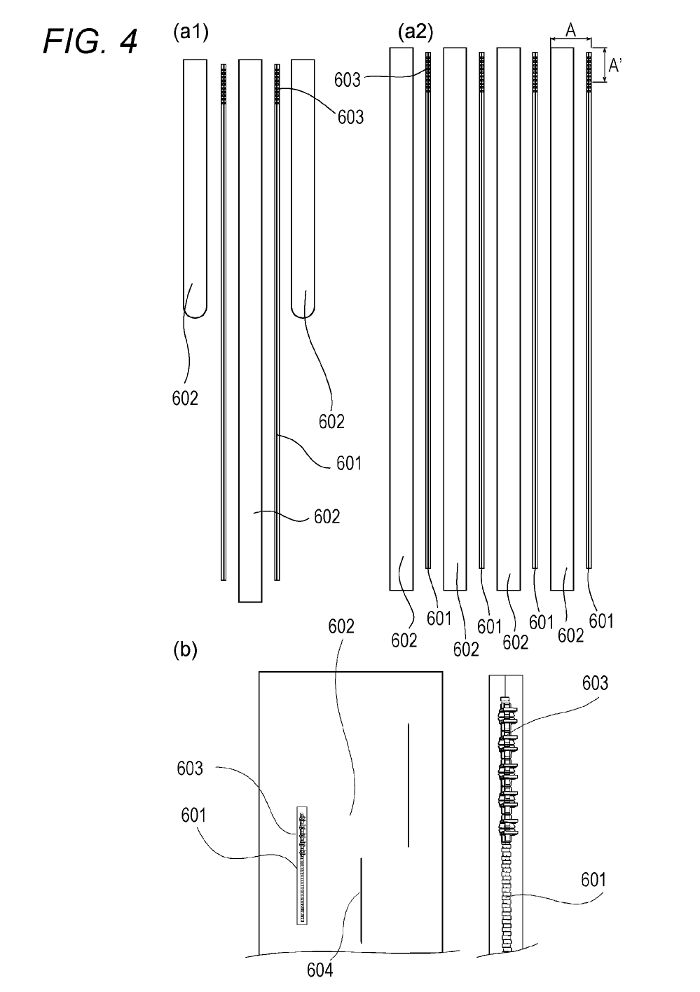

The present invention will be described with reference to FIGS. 1 to 4. FIG. 1 is an entire perspective view of the greening unit 10 according to the present invention. FIG. 1(a) illustrates an entire perspective view according to the basic structure of the present invention. FIG. 1(b) is an entire perspective view when adopting a structure in which plant-holding adapters 102 and 1002 and a watering pipe 701 are disposed to the basic structure. FIG. 2 is a state view in which plants are planted in the greening unit 10 according to the present invention. FIG. 3 is a cross-sectional view of the present invention. FIG. 4 is an exploded view of the greening unit 10 according to the present invention. FIGS. 4(a1) and (a2) are each a structural view of the case members 602 and the elements 601. FIG. 4(b) is an enlarged view of the slider 603 portion (A-A′ portion) of a fastener.

As illustrated in FIG. 1(a), the hollow body 101 has at least one or more case members 602. The element 601 is disposed to a side of the case member 602. At least two sliders 603 are disposed to a joint portion of the case members 602. Two sliders are spaced from each other to form an opening 604 along the joint of the case members. A plant 103 is planted in this opening 604. Accordingly, the plant 103 can be planted at an arbitrary height of the hollow body 101. It is noted that in the relationship between the element 601 and the slider 603 of a fastener, a term “fastener” as described herein contains a “chuck” and a “zipper”. Sealing fasteners such as a Ziploc (registered trademark) and an Easy Zipper (registered trademark) are also contained.

Although the material of the case member 602 is preferably non-permeable in consideration of use indoors, the non-permeable requirement is not necessarily satisfied when used outdoors. However, the material of the case member 602 is required to be capable of bending to some extent in both width and longitudinal directions. Examples of a specific suitable material include synthetic resins, such as polyethylene, polypropylene, polystyrene, and vinyl chloride polyester, which have high elastic modulus. Other rubber or leather materials may also be used without problem as long as they are easily bent. The length in the longitudinal direction of the case member 602 defines the length of a cylinder portion of the hollow body 101. The width direction constitutes the circumferential direction of the hollow body 101. In the present embodiment illustrated in FIG. 4(a2), the hollow body 101 is constituted by four case members 602. This means that one case member constitutes a quarter of the circumference of the hollow body. The present example includes four members. However, the number of members may be increased or decreased. Alternatively, the hollow body 101 may be constituted by three case members 602 having different lengths as illustrated in FIG. 4(a1). The long case member 602 is folded at its center. The folded case member 602 is linked with two case members 602 having the length that is half of the folded case member 602. This can reduce the number of components compared to the structure including four members.

Also, at least one or more slit portions are disposed on an interior region, of the case member 602, between the elements 601 of fasteners disposed along both sides of the case member 602. Furthermore, a fastener by the sliders 603 may also be disposed at arbitrary positions of both sides of a slit of the slit portion. Such a structure is also effective. Adoption of such a structure enables grasses and flowers to be planted in an arbitrary position such as when the elements 601 along both sides are wide. This is because there can be obtained the greening unit 10 in which more elaborated arrangement structure is enabled.

Although not illustrated in FIG. 4, the smallest structure may be configured such that one case member 602 constitutes the hollow body 101. Furthermore, the plant 103 is planted in an opening disposed along a joint of the case members 602. Therefore, the hollow body 101 is structured such that the joint of the case members 602 is positioned at the angle at which the plant 103 is desired to be arranged.

The element 601 is disposed to the long side of the case member 602. Two case members 602 are disposed along each other so that the element 601 for both is positioned. The sliders 603 are introduced along the element 601 from an edge of the long side of the case member 602. The sliders 603 are introduced from respective edges. In the case of known fasteners, the element 601 can be closed by introducing the sliders 603 only from one edge. This completes connection between members. However, in the present invention, the opening 604 needs to be disposed in the middle of the long side. For this reason, the sliders 603 are introduced from both edges.

When the opening 604 is not necessary, the sliders 603 are, for example, fixed around the middle of the long side so that two sliders 603 are brought into contact with each other. When desiring to plant a plant around the lower portion of the hollow body 101, two sliders 603 are moved to the vicinity of the lowest portion of the hollow body 101. A space having a length of several centimeters is disposed between two sliders 603 thereby to automatically generate the opening 604 for dewatering. The position in the vertical direction of the opening 604 can be easily adjusted by changing the positions of the sliders 603. The size of the opening 604 can also be easily changed by changing the positions of the sliders 603. Also, it is sometimes desired to add one more opening 604 along one joint of the case member 602. In this case, an opening can be easily added by adding and introducing two sliders 603. For example, it is sometimes desired to further dispose an opening on the upper portion in addition to the opening 604 which has been disposed around the lower portion. In this case, two sliders 603 are introduced from the upper edge. At that time, sides, of the two sliders 603, on which the element 601 is to be opened, are in contact with each other. The added two sliders 603 being in contact with each other may be separated in the vicinity of the upper portion of the hollow body 101, thereby to newly form the opening 604. Thus, the number of openings 604 can be easily increased without limitation by increasing the number of sliders 603 in this manner.

The plant cultivation base material 1101 is poured into the hollow body 101. The plant cultivation base material 1101 is soil used for fixing and raising a plant planted in the opening 604 formed with the fastener, or a substituted product of the soil. This base material has water-retaining properties and fertilizer-retaining properties. Examples of this base material include commercially available gardening culture soils, and pellet-like and particulate bark mulching materials. The plant cultivation base material 1101 may be poured into the hollow region of the hollow body 101 through either opening of the hollow body 101. However, the fastener along the joint of the case members may be fully opened to unfold the hollow body 101 from the side direction, and the plant cultivation base material 1101 may be put through the unfolded hollow body. Thus, pouring of the base material can be extremely easily performed. Once the pouring has been completed, the fastener can be closed again. Water may be supplied to the plant cultivation base material 1101 through the opening on the upper portion of the hollow body 101 to be gradually permeated into the lower side. Alternatively, water may be flown into the watering pipe 701, and supplied through a watering hole 801 for watering. Water that has not been absorbed into the plant cultivation base material 1101 and a water-absorbing material 1201 is discharged from the lower portion of the hollow body 101.

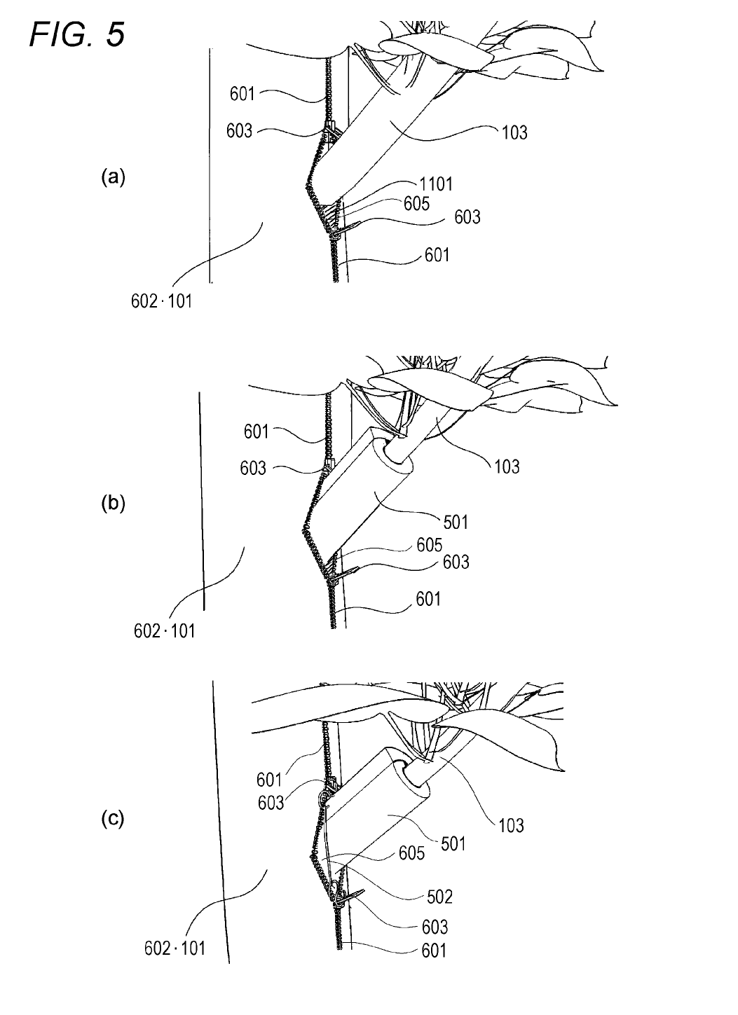

Next, an embodiment will be described with reference to FIG. 5. FIG. 5(a) is a perspective view of a plant directly inserted into an opening of a fastener. FIG. 5(b) is a state illustrative view when a plant winding unit 501 is utilized. FIG. 5(c) is a state illustrative view when a holder 502 is utilized.

The simplest method for inserting a plant into the opening, of the hollow body 101, which has been formed with a fastener, is a method of planting the plant 103 without utilizing any other auxiliary support and the like. Adjustment of the positions of the sliders 603 can determine the height and size of the opening. The size of the opening is determined so as to be larger than the thickness of the stem of the plant 103. The plant cultivation base material 1101 is exposed inside the opening. However, since the base material is somewhat condensed when poured into the hollow body 101, the base material has certain hardness, thereby inhibiting the base material from spilling too much. A root of a plant is inserted into the plant cultivation base material 1101 with fingers or the like. After the planting has been completed, the positions of the sliders 603 are adjusted such that the size of the opening is the size of the stem of the plant 103. A gap between the opening and the stem is reduced. Therefore, leakage of water, the plant cultivation base material 1101, and the like is small (FIG. 5(a)).

Also, the disposition of the plant winding unit 501 around the stem of the plant 103 can further reduce the gap between the opening and the stem. Accordingly, leakage of water, soil, and the like can be further reduced (FIG. 5(b)). The plant winding unit 501 is suitably a non-permeable soft member such as a sponge. Winding the plant winding unit 501 suitably prevents the stem of the plant 103 and the element 601 from being unnecessarily brought into contact with each other causing the stem to be scratched. The plant winding unit 501 may be disposed to the opening in a state of being previously wound around the plant 103. The plant winding unit 501 may be wound around the base of the stem of the plant 103 after the plant 103 is disposed to the opening.

Furthermore, the holder 502 may be disposed for preventing the sliders 603 from shifting in the direction in which the opening is widened, after the disposition of the plant 103 (FIG. 5(c)). Both edges of the holder 502 have a shape of, for example, a hook. The middle thereof is an elastic body. Each hook engages with one of the sliders 603 disposed on the upper and lower portions of the opening. Both of the sliders 603 are attracted to each other by a tension of the elastic body of the holder 502. This can prevent the opening from being widened.

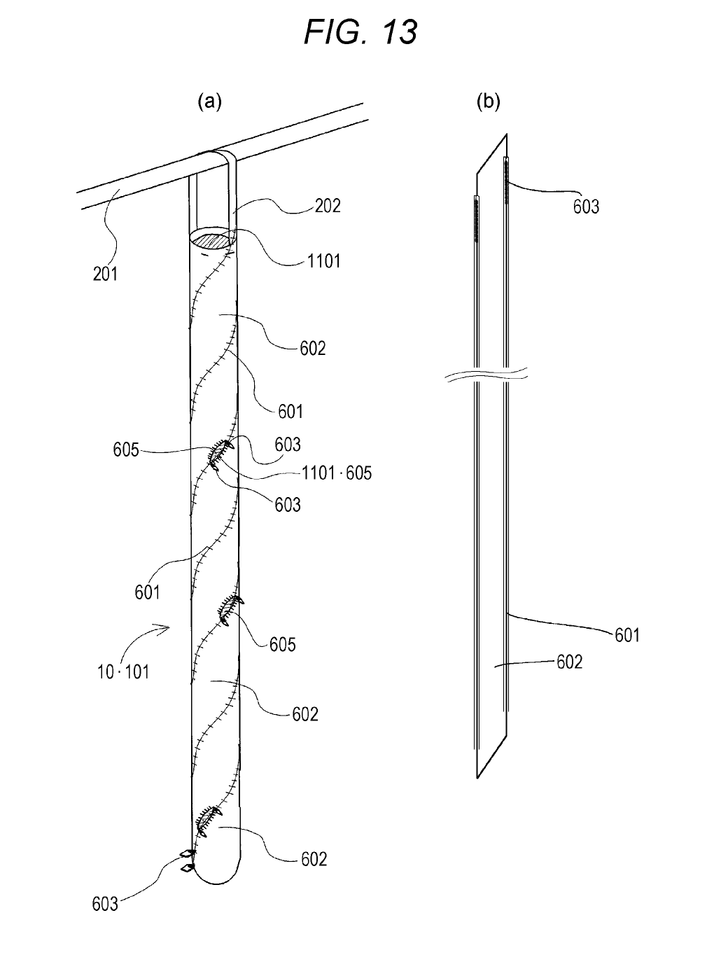

Next, a variation of Example 1 will be described with reference to FIG. 13. FIG. 13 is an implementation view in which the hollow body 101 is a substantially flat plate. The hollow body 101 is usually cylindrical. However, the use of a number of substantially flat plate-like case members 602 enables formation of the wall-like greening unit 10. The joints of the case members 602 are equally spaced. Therefore, plants can be optionally arranged all over the wall. As the case member 602, the same case member can be used. Therefore, the greening unit can be optionally expanded and deformed.

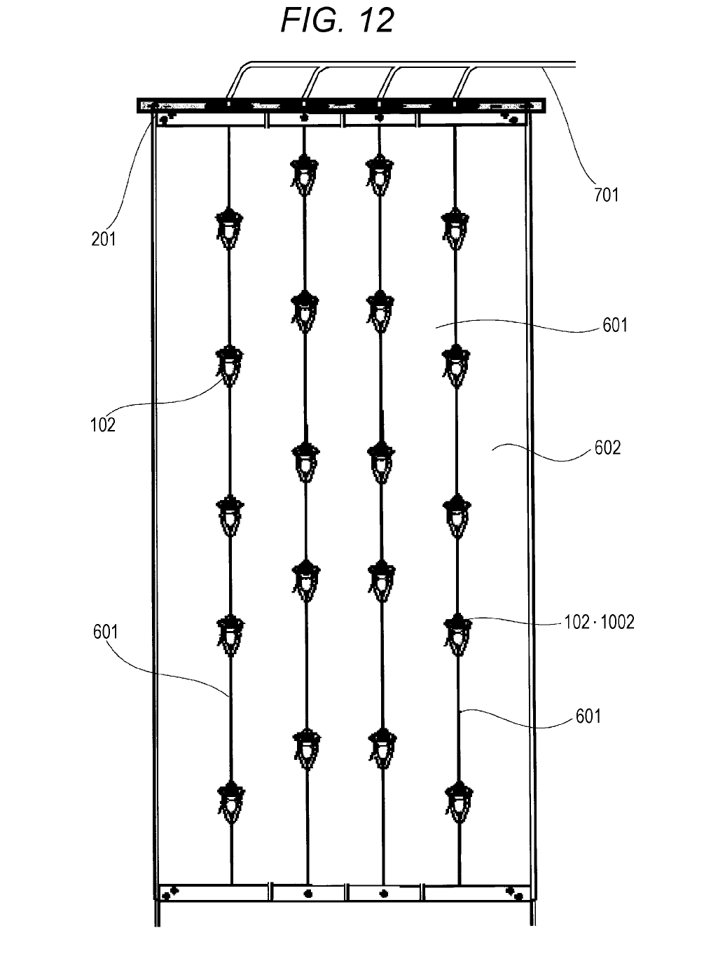

As described above, according to the present invention, a user can optionally determine the position (height) at which a plant is to be planted. For example, when the present invention is used as a green partition (FIG. 12), plants can be arranged in accordance with the sizes of the plants and the number of plants. Furthermore, since the present invention has a fastener structure, the number of sites to be arranged can be increased only by increasing the number of sliders 603. On the other hand, a merit in manufacturing is obtained in that the width of the hollow body 101 can be changed only by changing the widths of the substantially strip-like case members 602 and the number of case members 602. Therefore, the number of variations can be easily increased. That is, when manufacturing the hollow body 101 having a different width, the case member 602 having a different size does not need to be manufactured. It is noted that in FIG. 12, frame bodies are illustrated along the left, right, top and bottom of the green partition. These can be used as necessary depending on the embodiment. Furthermore, a structure in which lattice-like frame bodies suppress deformation in shape is also effective.

In the specification in which five openings are vertically aligned, a known method includes forming five openings and disposing covers or the like. However, in the present invention, the element 601 of the fastener only needs to be disposed to one substantially strip-like case member 602. Consequently, an effect of reducing steps can be obtained as a merit in production.

### EXAMPLE 2

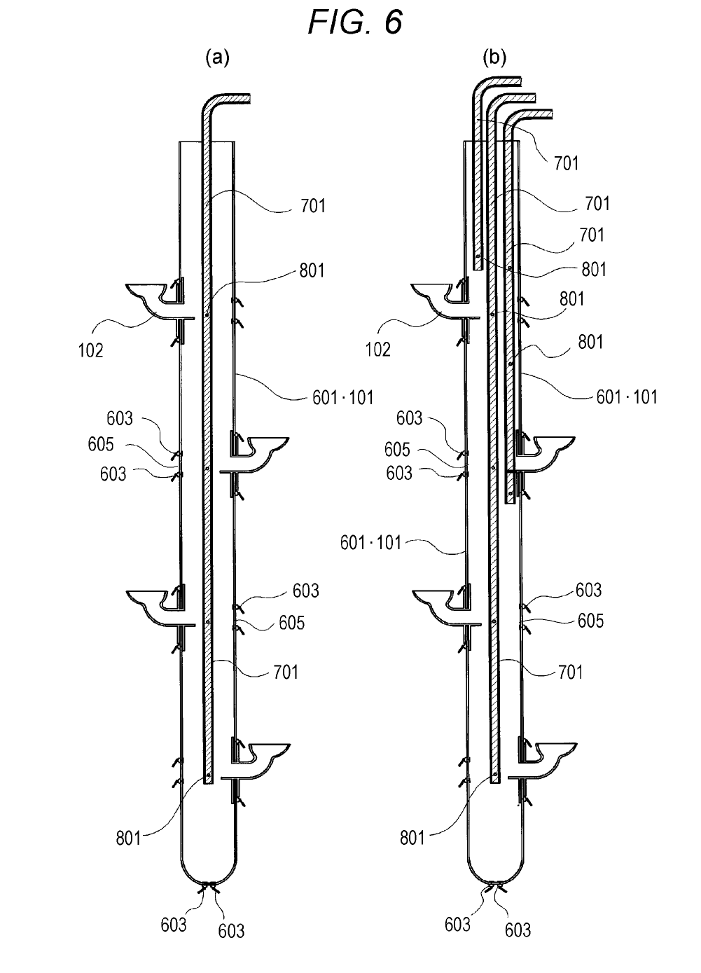

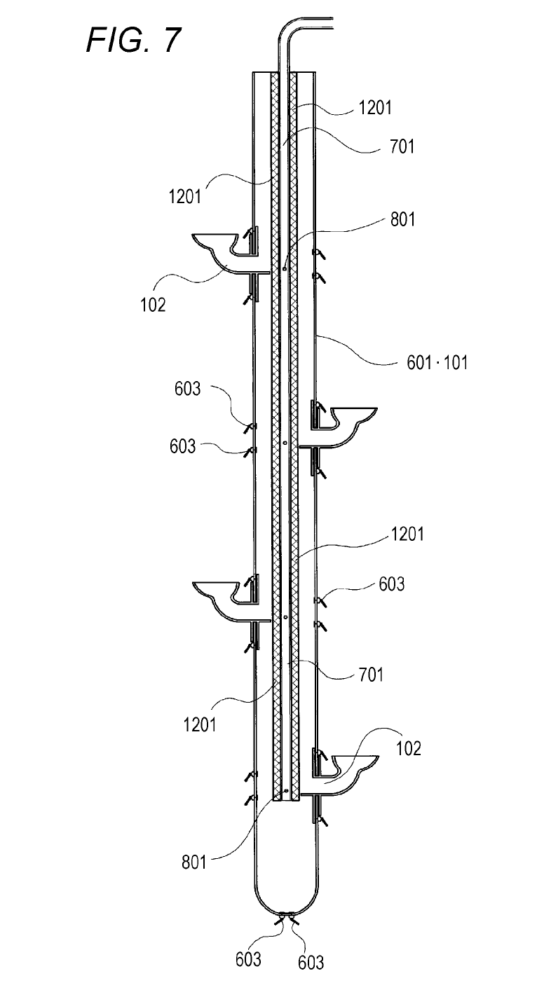

Another example will be described with reference to FIGS. 6 and 7. FIG. 6 is an illustrative view of the watering pipe 701 within the hollow body 101. FIG. 6(a) illustrates that one watering pipe 701 is disposed in a substantially central portion. FIG. 6(b) illustrates a state in which three watering pipes 701 each having a different length (depth) are disposed within the hollow body 101. FIG. 7 illustrates a structure in which the watering pipe 701 is disposed within the hollow body 101, and a water-retaining material 1201 is further disposed between the watering pipe 701 and the plant cultivation base material 1101.

The water-retaining material 1201 is provided for the purpose of reducing the frequency of watering works by preventing drying and retaining the water supplied by watering. Specific examples of the water-retaining material to be used include: a solid base floor for greening, obtained by pulverizing bark or saw dust and compression-molding the pulverized bark or saw dust with an inorganic paste which is harmless to plants; and a solid base floor for greening, obtained by molding polyurethane or phenolic resins into a porous shape. More specific example thereof includes Oasis (registered trademark).

When water is supplied into the hollow body 101 by simply watering the plant cultivation base material 1101 from the opening on the upper portion, water is possibly rapidly flown through the hollow body 101 and discharged from the lower portion. For this reason, water also possibly overflows from a water-receiving tray. To address this concern, the watering pipe 701, which is thinner than the thickness of the hollow body, is disposed near the central axis inside the hollow body 101. A plurality of watering holes is formed on the watering pipe 701 (FIG. 6). When a user pours water into the watering pipe 701, the water gradually permeates the plant cultivation base material 1101 through the watering holes 801. Therefore, water is inhibited from being rapidly flown through the hollow body 101. Thus, labor for watering can be reduced. In addition, covering the watering pipe 701 with the water-retaining material 1201 allows water to be flown further slowly (FIG. 7). In watering, water gradually permeates the plant cultivation base material 1101 through the watering holes 801 of the watering pipe 701. However, since the hollow body 101 has a vertically long structure, the upper portion of the plant cultivation base material 1101 is likely to be dried. To address this concern, the watering pipe 701 is covered with the water-retaining material 1201 so that water can be retained within the hollow body 101 for an extended period. This can lengthen an interval between watering works and reduce the amount of water to be supplied.

The watering hole 801 may be a round hole or an incision. The shape and size of the watering hole 801 are not limited, as long as the watering hole 801 is a hole that can exert a function necessary for watering. The number of watering pipes may be two or more. In that case, a plurality of tubes each having a different length may be used as the watering pipes 701 for the upper portion, the middle, and the lower portion of the hollow body 101. Also, for reducing labor for watering works, a pump or a water supply valve may be operated by a timer or the like for watering, so that the watering time and frequency can be set by the timer.

### EXAMPLE 3

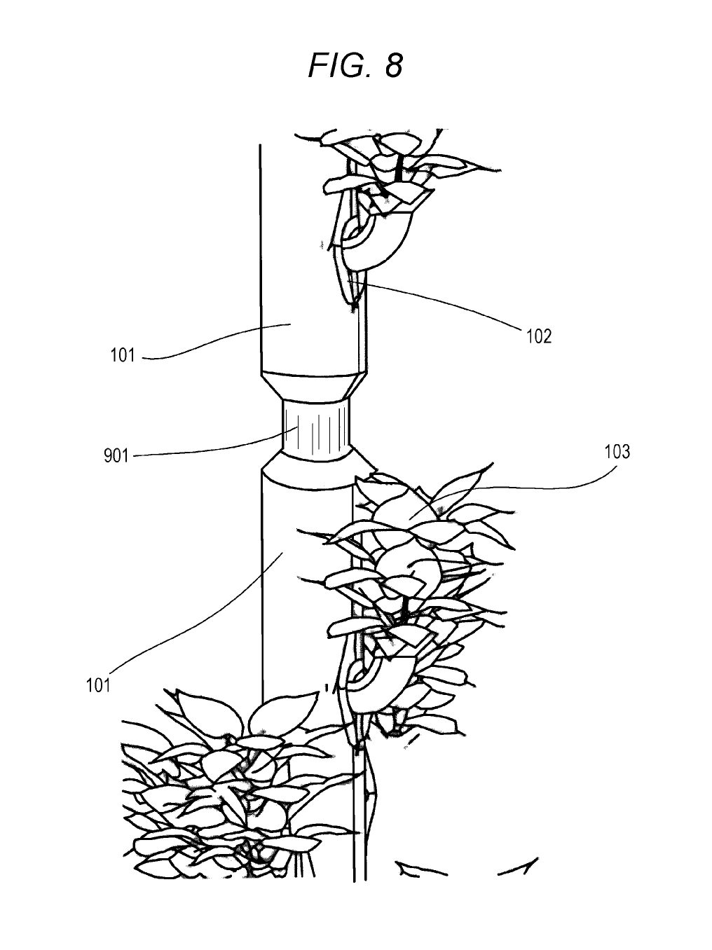

Another example will be described with reference to FIG. 8. Portions similar to Example 1 will be omitted. FIG. 8 is an illustrative view of the hollow body 101 capable of bending.

The inside of the hollow body 101 is divided into a poured region in which a plant cultivation base material such as soil and a plant culture as an alternative to soil is placed, and a non-poured region 901 in which the plant cultivation base material is not placed. The non-poured region 901 is a cavity. The case member is a member having flexibility. Therefore, the hollow body 101 can be easily bent at the non-poured region 901. Accordingly, the hollow body 101 can be structured to be easily pushed away. Consequently, the hollow bodies 101 can be horizontally opened by the non-poured region 901 in a state where a plurality of hollow bodies 101 having a hanging structure are disposed, so that a human easily passes through. As a method for securing the non-poured region 901, bonding or fusing a partition, clipping a partition, sewing, and the like are conceivable.

### EXAMPLE 4

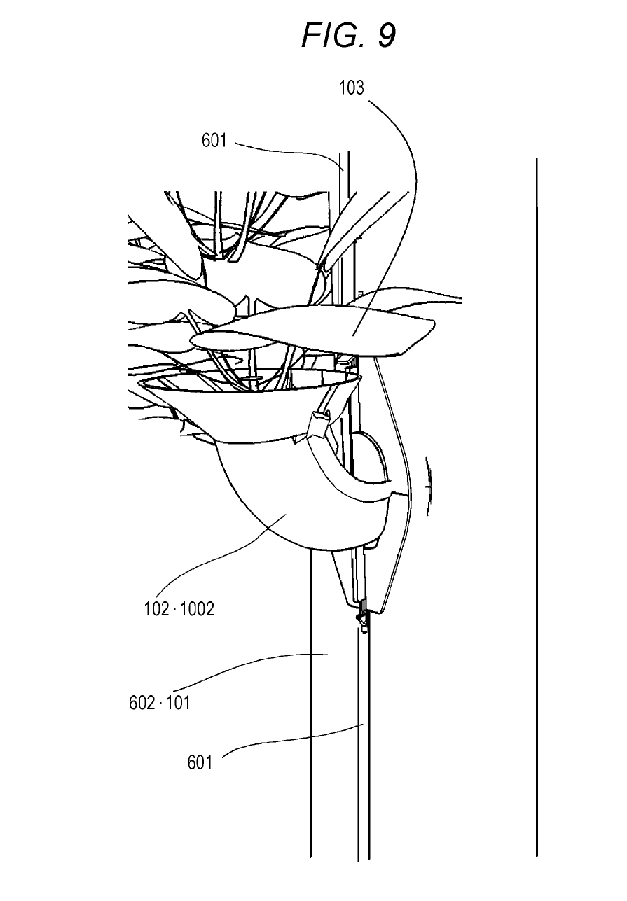

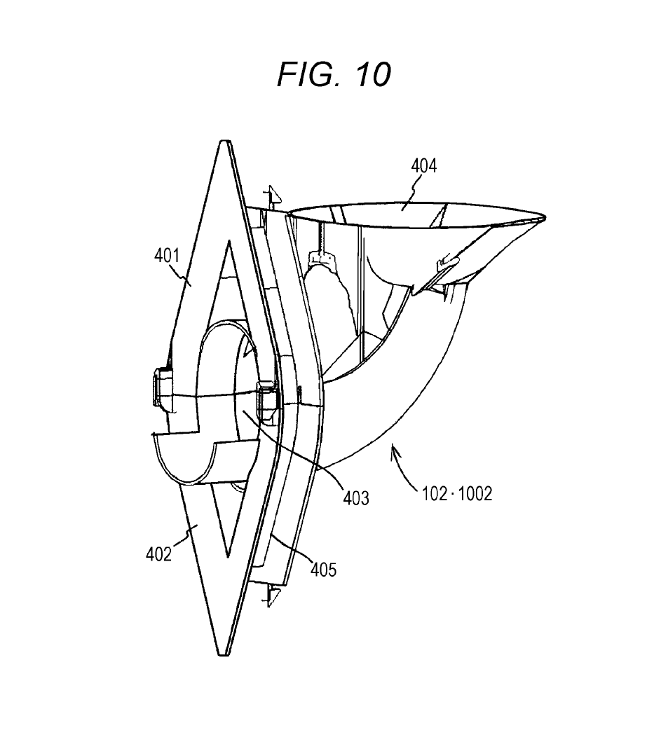

Another example will be described with reference to FIGS. 9 and 10. Portions similar to Example 1 will be omitted.

FIG. 9 is a schematic illustrative view of the plant-holding adapter 102 that holds a plant. FIG. 10 is a schematic illustrative view of the plant-holding adapter 1002 having a divided structure.

The plant-holding adapters 102 and 1002 are inserted into the opening formed by the fastener. These adapters gradually guide a plant from the opening in the direction parallel to the ground to hold the plant. Two flange-like steps 405, each having an area wider than the opened plane of the opening, are formed to the adapter. The case member 602 is put between the flange-like steps 405. This can prevent the plant cultivation base material 1101 such as soil from leaking from the case member 602.

A plant can be planted in a more stable manner by disposing a holding unit (hereinafter, referred to as an adapter 102) that holds plants, to the opening formed by the fastener of the hollow body 101. The plant-holding adapter 102 is integrally formed. Part of the upper side of the plant-holding adapter 1002 can be opened and closed. When the structure in which the upper side of the adapter 1002 can be opened is adopted, a plant can be more easily inserted into the opening. Accordingly, a plant having soil on its root is arranged and planted in the adapter 102 (FIG. 8). In the present embodiment, the upper and lower portions of the adapter 102 can be separated, and thus the top of the adapter 102 can be opened. In such a case, the opening may be forced open by using a slit disposed on the upper portion.

Furthermore, an air hole, passing through from the inside to the outside of a flower pot, is preferably disposed to part of the adapter 102 and the adapter 1002. This can also allow for adoption of a structure in which the inside of the long hollow body 101 is prevented from becoming stuffy, and supply of oxygen to a root is improved (FIG. 10). This is because the disposition of the air hole can improve the stuffiness and insufficient oxygen supply which are attributable to material properties of the hollow body 101 which is long and has poor air permeability.

### EXAMPLE 5

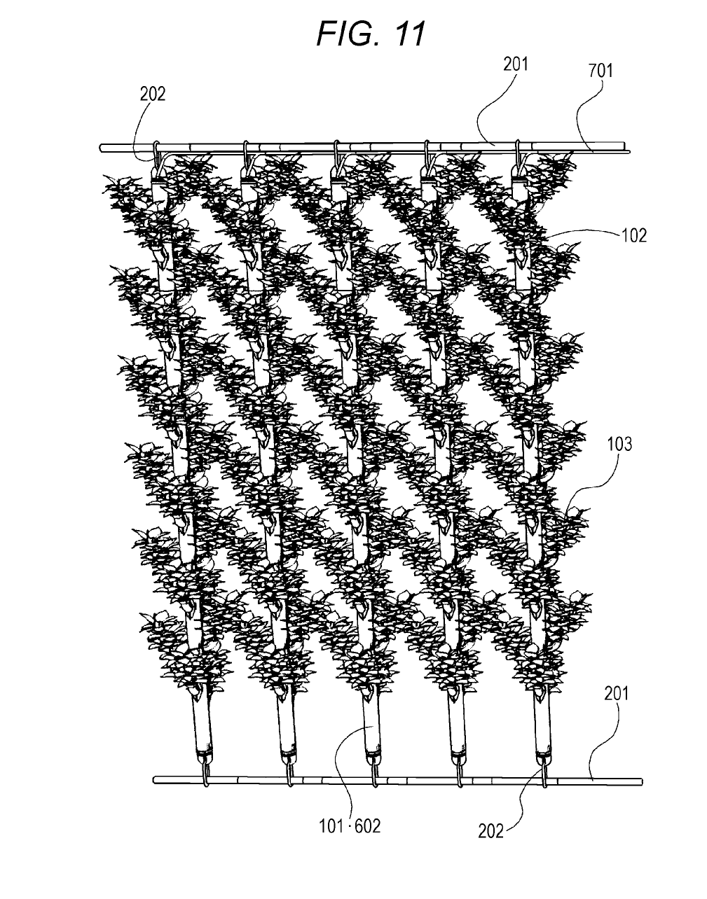

Another example will be described with reference to FIGS. 2 and 11. Portions similar to Example 1 will be omitted.

FIG. 2 is an illustrative view of the hanging structure of the hollow body 101. FIG. 11 is a view in which a plurality of hollow bodies 101 is disposed to form a green curtain-like structure.

The hollow body 101 is hung, at its upper end, on a hanging bar 201 via an engaging tool 202 to obtain the greening unit 10 that can be easily installed even indoors (FIG. 2). A plug 203 may be further added to the opening on the upper end of the hollow body 101 (FIG. 2). The hollow body 101 may also be hung via the engaging tool 202 provided to the plug 203. Furthermore, a plurality of hollow bodies may be arranged to form a curtain-like structure as illustrated in FIG. 11. In this case, as also illustrated in the drawing, the lower portion of the hollow body 101 can also be effectively fixed to the hanging bar 201 via the engaging tool 202 using a similar structure. In this case, the hollow body 101 is fixed at its upper and lower ends. Therefore, the hollow body 101 can be stably arranged. On the other hand, the engaging tool 202 may be used only on the upper end to form a bamboo blind-like structure with hollow bodies. With respect to the relationship between the engaging tool 202 and an engaged object in fixing, the engaging tool to be used when the engaged object is a bar-like body like the hanging bar 201 is preferably an engaging tool that can rotate and slide in a normal use state while being capable of tightly fixing the hollow body in strong winds or the like. Specifically, the engaging tool 201 preferably has a fixing structure or fixing mechanism such as clipping by an elastic member such as a spring, screwing with wing bolts, and fitting by mating. It is noted that when the engaging tool 201 is a string-like structure like a hook (FIG. 2 and FIG. 11) and does not have a fixing mechanism, a fixing tool may be separately used.

When the hanging bar 201 has a rail structure, the hollow bodies 101 can be easily moved. In such a structure, the hollow bodies 101 can be opened and closed like a curtain corresponding to the amount of sunlight. The amount of sunlight entering a room can be adjusted by drawing several hollow bodies, and by changing the number of hollow bodies in front of windows or the like. Accordingly, there can be reduced wasted use of electric lights in the evening, the rainy weather, or the cloudy weather where the amount of sunlight is small.

According to the present invention, a wide range of plants can be appreciated as a green curtain through a window (FIG. 11). For example, variety can be appreciated in which direct sunlight-resistant plants are planted at an outer side where the plants are exposed to sunlight to create the shadow, and direct sunlight-sensitive plants are planted at an inner side that is a window side. Various plants can be appreciated through windows all around in all seasons, thereby providing healing effects. In known green curtains, plants have been directly planted in the ground or in a planter. For this reason, there has been a problem that plants for a green curtain do not play a role as a green curtain before they grow to a certain level of height. However, light shielding effects can be obtained earlier by hanging the hollow bodies 101 according to the present invention, in which plants grown to some extent have been planted, when they become necessary. The planter or direct planting becomes an obstacle for people passing through there. However, the hanging-type hollow bodies can be moved along a rail. Therefore, people can pass through. The hollow bodies can also be installed in places where the ground is covered with concrete or asphalt. Therefore, the hollow bodies can also be installed to an apartment building in which the window faces a parking area or a road. Plants may be planted so as to be concentrated at the height of people's eyes, thereby enhancing blinding effects. Instead of arranging plants like a green curtain over a window, the hollow bodies are just hung, and the hung hollow bodies look like a tree of grasses and flowers. Therefore, there can be provided a plant appreciation method that has not been often practiced.

The yield per unit area is limited when vegetables or the like are cultivated in known flower pots or outdoors. Even when cultivating plants in flower pots placed on racks or the like, it is considered that the height of the racks cannot be increased too much in view of harvesting. According to the present invention, a space can be effectively utilized when planting plants. Therefore, the yield per unit area when cultivating vegetables or the like can be easily increased. The yield can be increased even in a small place. With respect to harvesting at a high position, crops can be easily harvested by lowering the height of the hanging tool when harvesting, for example, even in cultivation with the hollow body 101 having a length of 3 m.

FIG. 13 is an illustrative perspective view of an application example of the greening unit according to the present invention. FIG. 13(a) illustrates an embodiment in which the case member 602 is structured to have a spiral-like shape. FIG. 13(b) is an unfolded view as a component. When the case member is placed in a spiral-like manner, the positional relationship can be adjusted so that the position of a slider 303 shifts in the longitudinal direction. There is adopted a structure in which pulling the slider allows for formation of the hollow body 101 including the spiral-like case member 602. Such a structure enables the position of the opening to be optionally selected either in the circumferential direction or in the longitudinal direction with only one case member 602.

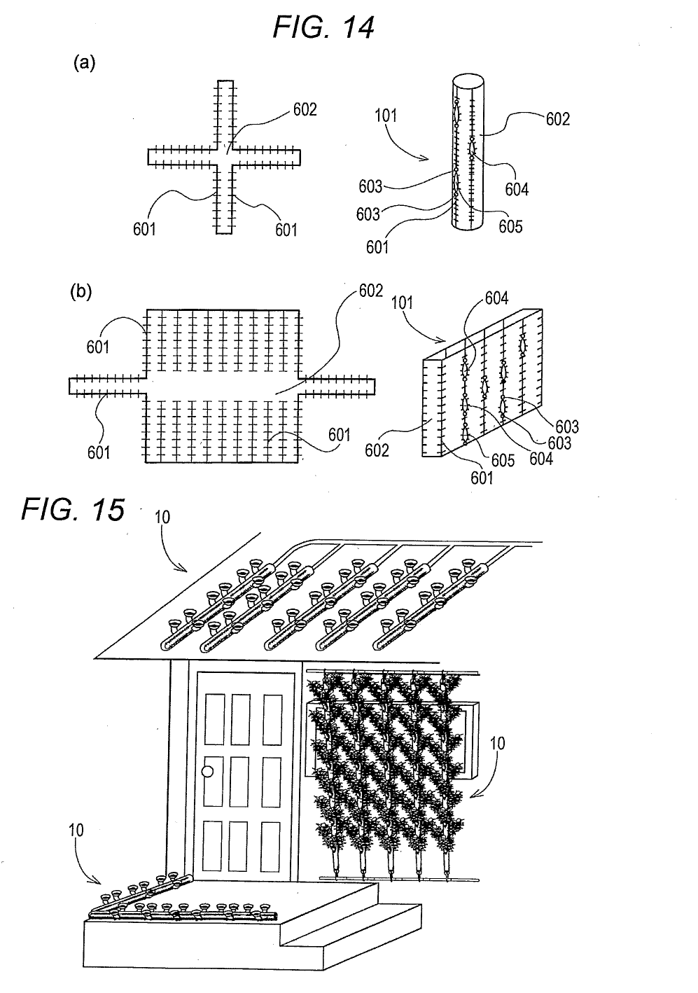

FIG. 14 is an unfolded diagram illustrating another embodiment of the case member 602 constituting the hollow body 101 that is a basic structure of the greening unit 10 according to the present invention. The case member 602 of the greening unit 10 according to the present invention may have a shape illustrated in FIG. 14. FIG. 14(a) illustrates a structure according to claim 1 that is a basic structure of the present invention. However, there is illustrated a structure in which linkage of the end, which is one end of the hollow body 101, becomes unnecessary. In FIG. 14(a), there is formed the substantially tubular hollow body 101 which is constituted by four sides. In FIG. 14(b), the case member has a shape of a substantially flat plate. This case member has increased blinding effects, thereby suitable for when a large facility hall needs to be partitioned.

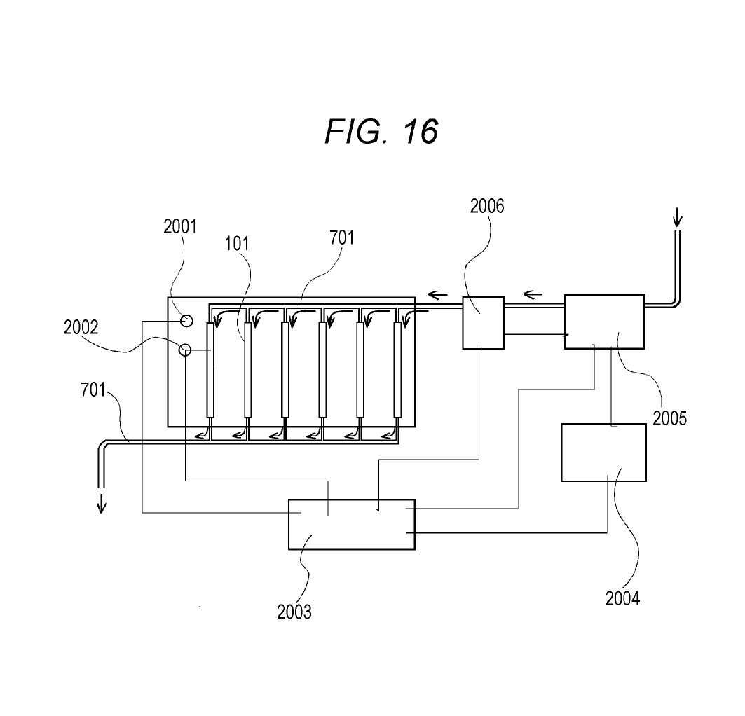

FIG. 16 is a schematic illustrative diagram of an automatic control-type watering system of the greening unit according to the present invention. In this structure, the necessary water content is calculated from a moisture sensor 2002 and a temperature sensor 2001 according to a control program stored in a control panel 2003. This is an application example to a system in which water supply management is automated by controlling on/off of a power supply unit 2004, a pump 2005, and a solenoid valve 2006 under sequence control. The adoption of such a structure provides effects of facilitating water supply works when a curtain-like or partition-like large scale system is formed with a number of greening units according to the present invention. The scale of the system is enlarged when used, for example, for decoration of a show window at a department store. Therefore, this system is effective in that troublesome works of supplying water to pots one by one are not necessary, and management can be automatically performed corresponding to changes in weather and temperature.

### INDUSTRIAL APPLICABILITY

The greening unit according to the present invention can meet various needs such as gardening tools, seedling raising tools used by flower producers, display tools in stores, and tools for greening in towns. The greening unit can be applied to a wide range of fields, from a small-scale use by individuals or in homes to vegetable or fruit producers in large-scale orchards and farms. Thus, it is understood that industrial applicability of the greening unit is significant in such a wide range in the agricultural field.

### LIST OF NUMERAL REFERENCES

10 greening unit
101 hollow body
102 plant-holding adapter
103 plant
201 hanging bar
202 engaging tool
203 plug
301 hollow body fixing unit
401 upper portion of adapter
402 lower portion of adapter
403 opening on lower portion of adapter
404 opening on upper portion of adapter
405 flange-like step
501 plant winding unit
502 holder
601 element
602 case member
603 slider
604 slit
605 opening
701 watering pipe
801 watering hole
901 non-poured region
1001 air hole
1002 plant-holding adapter
1101 plant cultivation base material
1201 water-retaining material

1. A greening unit in which various plants are allowed to be planted at an arbitrary position, comprising
at least one or more case members, wherein
each of the case members contains a material capable of bending, and has an element of a fastener on two sides that serve as a pair,
the element is closed by sliders of the fastener to form a hollow body having a hollow region enclosed with the case member,
a plant cultivation base material is poured into the hollow region,
at least two or more of the sliders are disposed to one fastener structure, and
positions of the sliders are adjusted to form an opening along part of the fastener, and a plant is allowed to be planted to the plant cultivation base material through the opening.

2. The greening unit according to claim 1, wherein
in the case member, one or both of at least one or more slit portions and at least one or more slit portions with the fastener by the sliders are disposed at arbitrary positions in an interior region between the elements of the fasteners on the two sides that serve as a pair.

3. The greening unit according to claim 1, wherein
a watering pipe is disposed inside the hollow region of the hollow body,
at least one or more watering holes are disposed to the watering pipe, and
water poured into the watering pipe is supplied to the plant cultivation base material through the watering holes.

4. The greening unit according to claim 3, wherein
a water-retaining material covers a periphery of the watering pipe, and
the plant cultivation base material is poured into the hollow region on a periphery of the water-retaining material.

5. The greening unit according to claim 1, wherein
the hollow region of the hollow body includes:
a poured region in which the plant cultivation base material is poured; and
a non-poured region in which the plant cultivation base material is not poured, and
the hollow body is capable of bending at the non-poured region.

6. The greening unit according to claim 1, further comprising
an adapter that is to be inserted into the opening, and gradually leads the plant from the opening to a direction parallel to the ground to hold the plant, wherein
two flange-like steps, each having an area wider than an opened plane of the opening, are formed to the adapter, and
the adapter is a plant-holding adapter that holds the case member between the flange-like steps for preventing the plant cultivation base material from leaking from the case member.

7. The greening unit according to claim 6, wherein
the plant-holding adapter is a plant-holding adapter having a divided structure in which a pipe line of the adapter is halved.

8. The greening unit according to claim 1, wherein
the greening unit includes an engaging tool disposed on an edge of the greening unit, and is to be hung on an engaged object via the engaging tool for arrangement.

9. The greening unit according to claim 2, wherein
a watering pipe is disposed inside the hollow region of the hollow body,
at least one or more watering holes are disposed to the watering pipe, and
water poured into the watering pipe is supplied to the plant cultivation base material through the watering holes.

10. The greening unit according to claim 9, wherein
a water-retaining material covers a periphery of the watering pipe, and
the plant cultivation base material is poured into the hollow region on a periphery of the water-retaining material.

11. The greening unit according to claim 2, wherein
the hollow region of the hollow body comprises:
a poured region in which the plant cultivation base material is poured; and
a non-poured region in which the plant cultivation base material is not poured, and
the hollow body is capable of bending at the non-poured region.

12. The greening unit according to claim 3, wherein
the hollow region of the hollow body comprises:
a poured region in which the plant cultivation base material is poured; and
a non-poured region in which the plant cultivation base material is not poured, and
the hollow body is capable of bending at the non-poured region.

13. The greening unit according to claim 2, further comprising
an adapter that is to be inserted into the opening, and gradually leads the plant from the opening to a direction parallel to the ground to hold the plant, wherein
two flange-like steps, each having an area wider than an opened plane of the opening, are formed to the adapter, and
the adapter is a plant-holding adapter that holds the case member between the flange-like steps for preventing the plant cultivation base material from leaking from the case member.

14. The greening unit according to claim 3, further comprising
an adapter that is to be inserted into the opening, and gradually leads the plant from the opening to a direction parallel to the ground to hold the plant, wherein
two flange-like steps, each having an area wider than an opened plane of the opening, are formed to the adapter, and
the adapter is a plant-holding adapter that holds the case member between the flange-like steps for preventing the plant cultivation base material from leaking from the case member.

15. The greening unit according to claim 13, wherein
the plant-holding adapter is a plant-holding adapter having a divided structure in which a pipe line of the adapter is halved.

16. The greening unit according to claim 14, wherein
the plant-holding adapter is a plant-holding adapter having a divided structure in which a pipe line of the adapter is halved.

17. The greening unit according to claim 2, wherein
the greening unit includes an engaging tool disposed on an edge of the greening unit, and is to be hung on an engaged object via the engaging tool for arrangement.

18. The greening unit according to claim 3, wherein
the greening unit includes an engaging tool disposed on an edge of the greening unit, and is to be hung on an engaged object via the engaging tool for arrangement.
